(19) United States
(12) Patent Application Publication
(10) Pub. No.: US 2019/0077210 A1
(43) Pub. Date: Mar. 14, 2019

(54) IMPROVED SUSPENSION

(71) Applicant: QUADRO VEHICLES S.A., Vacallo (CH)

(72) Inventors: Marco MORONI, Marnate (IT); Riccardo MARABESE, Gallarate (IT)

(21) Appl. No.: 16/085,401

(22) PCT Filed: Mar. 15, 2017
(86) PCT No.: PCT/EP2017/056053

§ 371 Date: Sep. 14, 2018

(30) Foreign Application Priority Data
Mar. 15, 2016 (IT) 102016000027055

(51) Int. Cl. B60G 17/04; B60G 11/30; B60G 17/08; B60G 21/073

(52) U.S. Cl. CPC B60G 17/0424; B60G 11/30; B60G 17/0432; B60G 17/08; B60G 2300/45; B60G 2202/154; B60G 2206/4222; B60G 2300/122; B60G 2300/124; B60G 21/073

(57) ABSTRACT

The present invention relates to an improved suspension (20), in particular for traditional two-wheel motorcycles and/or for motorcycles or vehicles with three or more wheels with at least two tilting wheels. The improved suspension (20) according to the present invention is capable of providing adequately progressive performance without simultaneous problems of excessive gradual engagement, which affect the currently known suspensions comprising gas shock absorbers. Such a result is possible by using an accumulator (70) having a variable volume operatively connected to the first accumulator (60) which is part of the traditional suspension.

### FIELD OF THE INVENTION

The present invention relates to an improved suspension.

In particular, the suspension according to the present invention was conceived for traditional two-wheel motorcycles and/or for motorcycles or vehicles having three or more wheels with at least two tilting wheels, wherein however other uses thereof in other vehicles are equally possible.

Vehicles with tilting wheels are motor vehicles, motorcycles, scooters or the like which are generally provided with a pair of tilting front wheels and with one rear wheel; vehicles with two rear wheels are also considered. In general, the expression vehicles with tilting wheels has to be understood as meaning vehicles which have at least three wheels and which are capable of tilting sideways due to the presence of a so-called tilting system of the wheels coupled on the same axis, generally the front wheels.

### DESCRIPTION OF THE PRIOR ART

According to the known background art, vehicle suspensions comprise at least one shock absorber. In vehicles with two or more wheels, suspension systems connect the wheels to the frame. The suspensions comprise elastic shock absorbers which carry out the function of dampening the stresses transmitted from the road to the frame.

An example of such suspension and tilting systems is provided in FIG. 1, where system 1 comprises a pair of shock absorbers 10a in fluid connection to each other according to prior Patent PCT/EP2006/064794 to the same Applicant.

The various types of elastic shock absorbers may include spring systems, in turn comprising helical and leaf springs generally made of metal material, rubber springs and the like, according to the known prior art.

Alternatively, elastic shock absorbers may comprise gas springs.

In contrast to gas springs, metals springs, e.g. a helical spring, commonly used in traditional shock absorbers have a certain elastic constant which can be generally indicated by K.

Due to said constant, the elastic force opposed by the spring is linear with respect to the deformation: by way of example, with an elastic constant K being equal to 10, for each 10 kg of force axially applied to a helical spring, the length thereof varies by 1 mm. If a further axial force of 10 kg is applied to a spring already pre-loaded with 10 kg, the spring deforms again by 1 mm, until it reaches its maximum deformation, while sandwiching.

Gas springs instead are progressive. By way of example, if 100 kg of axial force are applied to a gas spring, the piston or membrane compressing the pressurized gas moves by a quota X.

By applying a further 100 kg, the piston or membrane moves by a quota Y, which is less than X because the bulk modulus of compressibility of a gas is not constant but depends on density. The denser the gas, the greater the variation in pressure required to obtain a further decrease of the volume.

The excessive gradual engagement of gas springs creates a problem of excessive rigidity of the suspension, generally from mid-stroke onward, thus adversely affecting the driving comfort.

### SUMMARY OF THE INVENTION

It is the main task of the present invention to provide an improved suspension which allows to overcome the drawbacks left unsolved by solutions of known type. Within this task, it is the object of the present invention to provide a suspension capable of providing an adequately progressive performance without having simultaneous problems of excessive gradual engagement, which affect the currently known suspensions comprising gas shock absorbers.

It is also an object of the present invention to improve the comfort offered by the gas suspension, both when driving alone and when driving with the passenger, and also when driving with the passenger and luggage.

Indeed, the improved spring system allows the suspension to be more effective throughout its work, and to be adequately adjusted in terms of pressures of the different chambers of the accumulators as a function of the type of use.

Thereby, it is possible to customize the performance of the suspension as a function of the type of use (sports, touring, etc.) and of the load weighing thereon (driving alone, with passenger, etc.). This task and these and other objects are achieved by an improved suspension according to appended claim 1.

Further features are mentioned in the dependent claims.

### BRIEF DESCRIPTION OF THE DRAWINGS

Further features and advantages of the present invention will be more apparent from the detailed description of a preferred embodiment, depicted by way of a non-limiting example in the accompanying drawings, in which:

FIG. 1 depicts a suspension and tilting system 1 referred to as HTS (Hydraulic Tilting System), for vehicles having tilting wheels, known from the prior art and belonging to the subject matter of International Patent Application PCT/EP2006/064794 assigned to the same Applicant;

FIG. 2a depicts the suspension and tilting system of FIG. 1, comprising an added accumulator with variable volume associated with the HTS suspension according to a first embodiment and to a first connection mode;

FIG. 2b depicts the suspension and tilting system of FIG. 1, comprising an added accumulator with variable volume associated with the HTS suspension according to a first embodiment and to a second connection mode;

FIG. 2c depicts the suspension and tilting system of FIG. 1, comprising a first added accumulator with variable volume associated with the HTS suspension according to a first embodiment and to a third connection mode;

FIG. 2d depicts the suspension and tilting system of FIG. 1, comprising a second accumulator with variable volume associated with the HTS suspension according to a first embodiment and to a fourth connection mode;

FIG. 3 depicts the suspension and tilting system of FIG. 2d in a first stroking step of the suspension system;

FIG. 4 depicts the suspension and tilting system in FIG. 2d in a second stroking step of the suspension system, at which the pressure value of the gas in the system is such as to cause the volume of the second accumulator with variable volume, to vary;

FIG. 5 depicts, in detail, the accumulator with variable volume according to a first embodiment of the present invention;

FIG. 6 depicts the suspension and tilting system of FIG. 1 with which an accumulator with variable volume according to a second embodiment is associated;

FIG. 6a depicts the suspension and tilting system of FIG. 6 in a first stroking step of the suspension system;

FIG. 6b depicts the suspension and tilting system of FIG. 6 in a second stroking step of the suspension system, at which the pressure value of the gas in the system is such as to cause the volume of the second accumulator with variable volume, to vary;

FIG. 7 depicts the suspension and tilting system of FIG. 1 with which an accumulator with variable volume according to a third embodiment is associated;

FIG. 7 depicts the suspension and tilting system of FIG. 7 in a first stroking step of the suspension system;

FIG. 7b depicts the suspension and tilting system of FIG. 7 in a second stroking step of the suspension system, at which the pressure value of the gas in the system is such as to cause the volume of the accumulator with variable volume, to vary;

FIG. 8 depicts a mono-shock absorber of the type suitable for forming the rear suspension of a motorcycle, with which an accumulator with variable volume according to a fourth embodiment of the present invention is associated;

FIG. 8a depicts a sectional view of the mono-shock absorber with accumulator of FIG. 8;

FIG. 9 depicts a motorcycle on which the mono-shock absorber with accumulator of FIG. 8, is installed;

FIG. 10 depicts a graph showing the compression of the suspension as a function of the load according to the various configurations.

### DETAILED DESCRIPTION OF THE INVENTION

The improved gas suspension 10, 10′, 10″, 20, 30, 40, 50 according to the present invention comprises at least one shock absorber 10a, 20a, 30a, 40a, 50a in fluid connection with at least a first accumulator 60, 80, 90, operatively connected to a second accumulator 70, 80a with variable volume, adapted to form an expansion chamber having a variable volume for said first accumulator 60, 80, 90.

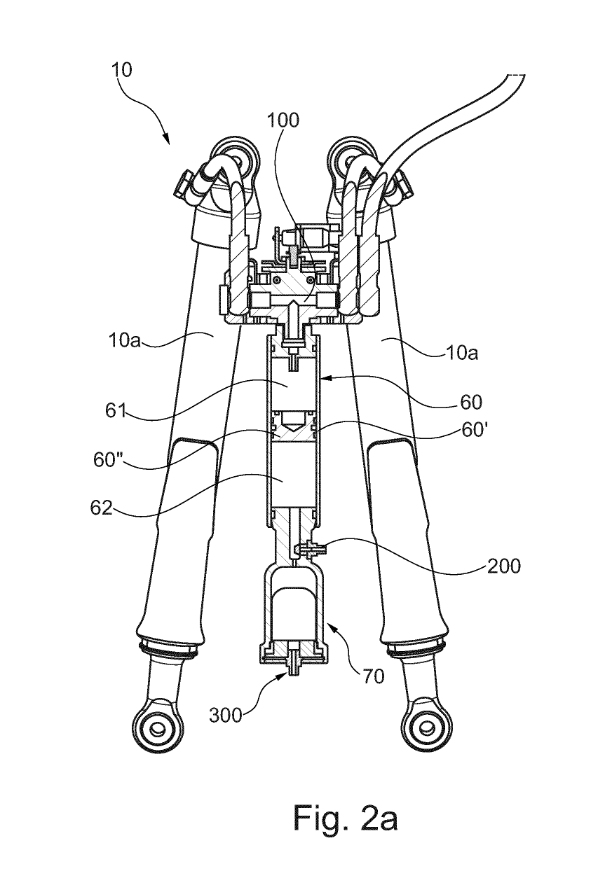

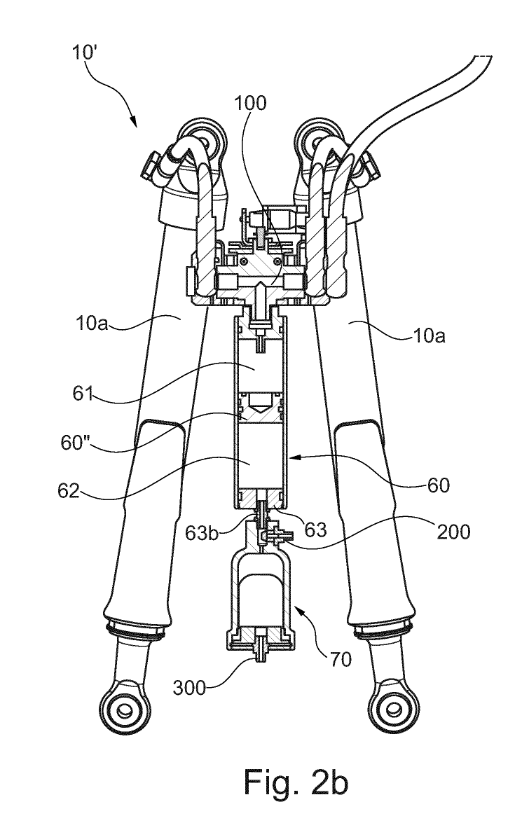

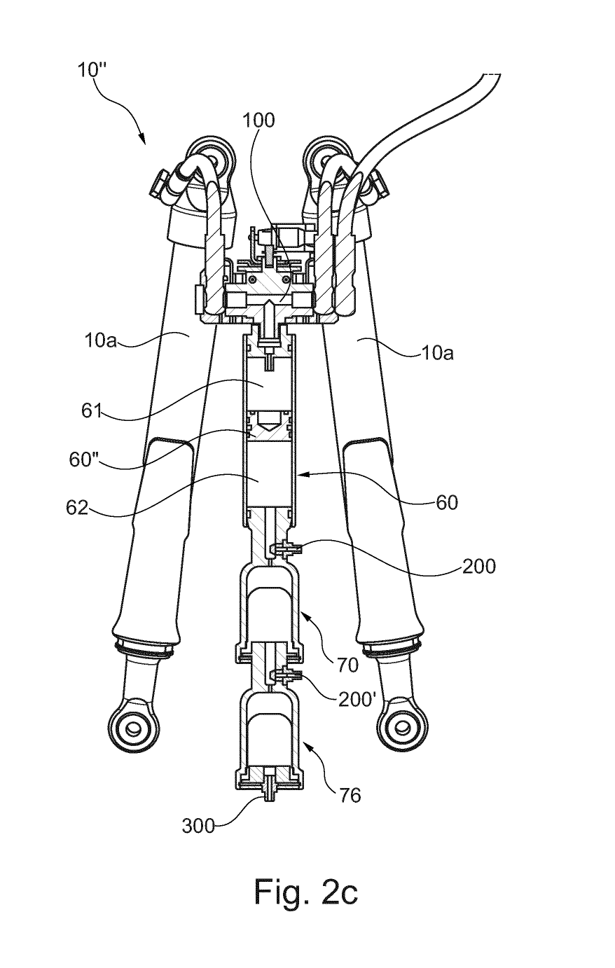

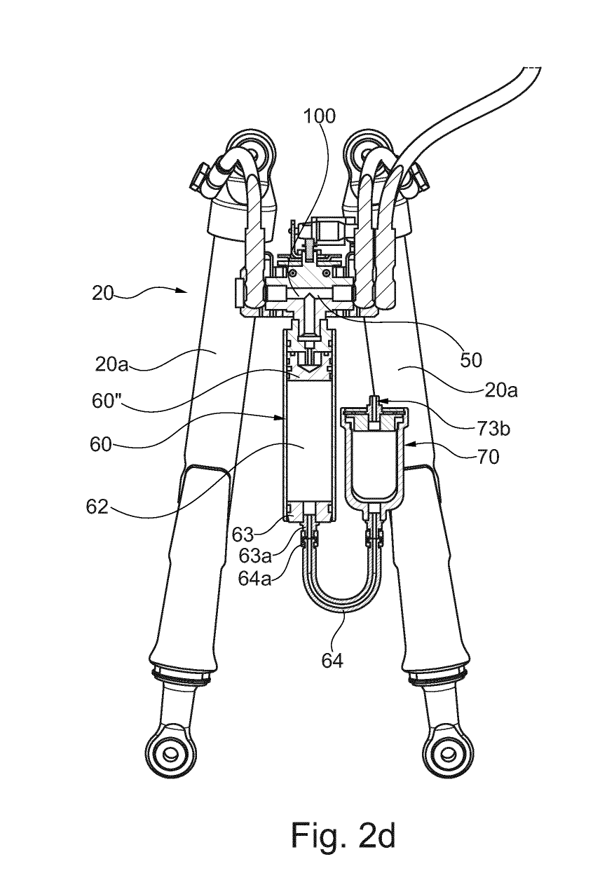

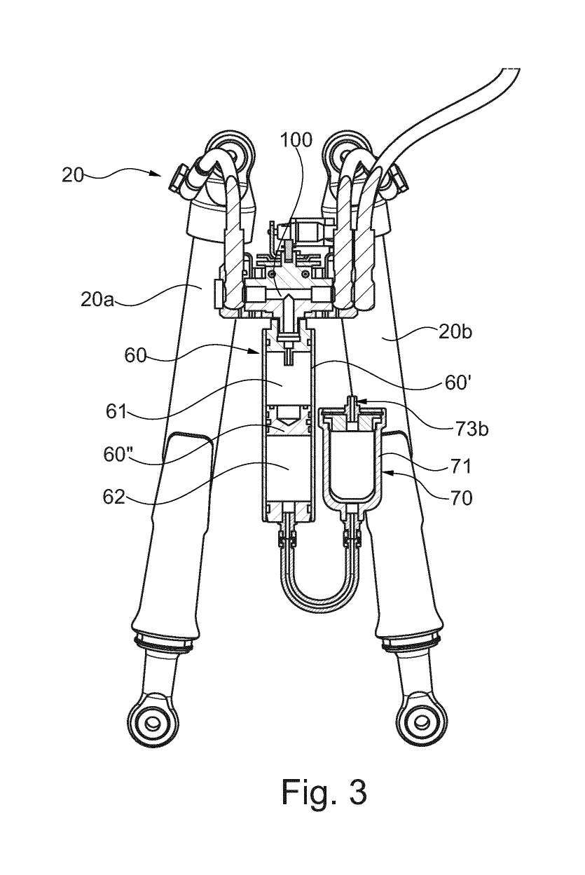

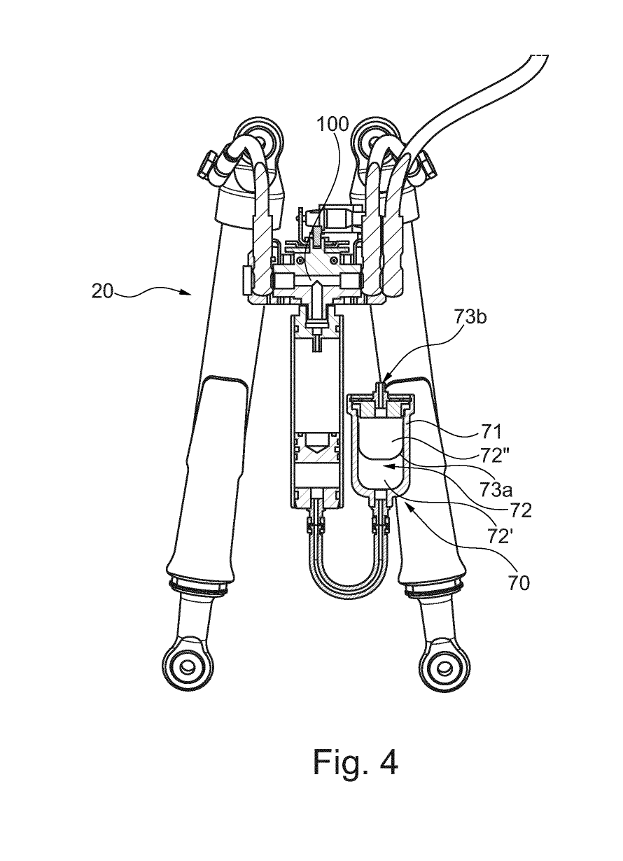

In the embodiments of FIGS. 2a to 7b, a suspension and tilting system in particular is shown for three- or four-wheel vehicles of which at least two are tilting wheels, and such a system comprises a pair of shock absorbers and each of said shock absorbers comprises at least one cylinder and at least one piston which is movable inside said cylinder and which divides the inner volume of the cylinder into two chambers, an upper chamber and a lower chamber. The upper chamber contains a working fluid in the liquid state, generally oil, and the lower chamber may also contain pressurized gas according to the teachings of PCT/EP2006/064794 mentioned above.

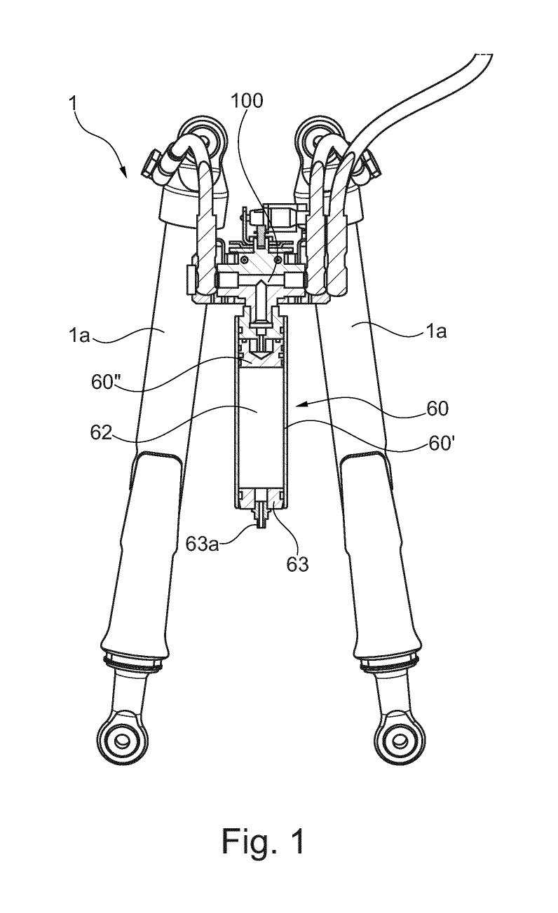

FIG. 1 depicts the suspension and tilting system known from PCT/EP2006/064794.

However, the present invention is not to be limited to the application to such a wheel suspension and tilting system according to the teaching of Application PCT/EP2006/064794, and therefore any suspension and tilting system comprising a pair of shock absorbers connected to each other in fluid connection may be equally provided.

Returning to the example depicted in the accompanying FIGS. 2a to 5, at least one of the chambers of a first of said shock absorbers 10a, 20a advantageously is in fluid connection by means of a connecting duct 100 with the corresponding chamber of a second of said shock absorbers 10a, 20a, and advantageously said connecting duct 100 is in fluid connection with a first accumulator 60 serving the function of damper.

Said first accumulator 60 in turn preferably comprises a containment cylinder 60′ inside of which there is provided a first partition wall 60″ slidably associated inside said containment cylinder 60′ so that the working fluid, preferably oil as said, which flows through said duct 50 during the operation of the system, passing from the first to the second shock absorber and vice versa, may also expand inside said containment cylinder 60′, in particular in an upper chamber 61 defined by said partition wall 60″ inside cylinder 60′, thus overcoming the resistance to the sliding of the partition wall 60″ generated by the presence of pressurized gas in the lower chamber 62 of said cylinder 60′.

The suspension according to the present invention further comprises a second accumulator 70 in fluid communication with said first accumulator.

Said second accumulator 70 is characterized in that it has a variable volume.

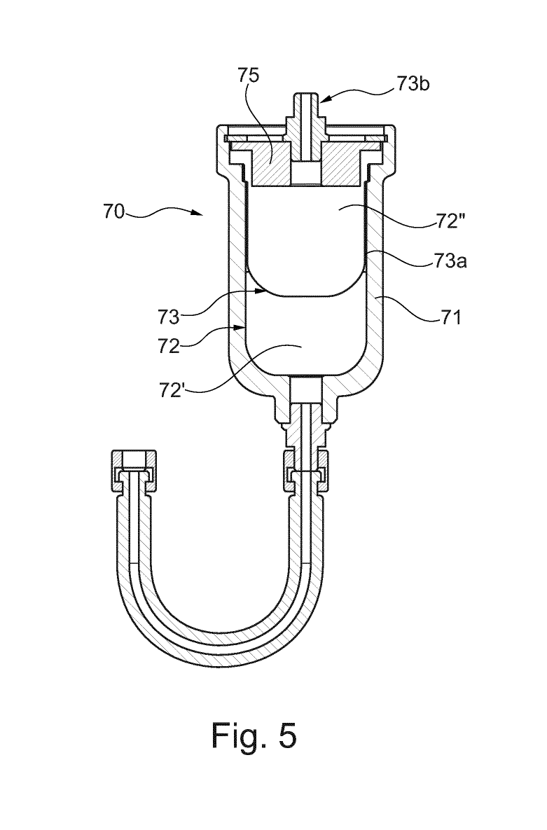

According to a first embodiment of the suspension according to the present invention, and with particular reference to the detail in FIG. 5, the second accumulator 70 having a variable volume comprises a preferably substantially cylindrical containment element 71 defining therein an expansion chamber 72 having a variable volume.

Separation means are conveniently provided inside said containment element 71 in order to vary the volume of the expansion chamber 72, said separation means 73 being adapted to divide said expansion chamber 72 into two parts; a first part 72′ in fluid communication with said first accumulator 60 and a second part 72″ containing contrast means suitable for counteracting the displacement of said separation means 73, thus counteracting the volume increase of said first part 72′ of said expansion chamber 72.

According to a first embodiment of the present invention shown in FIGS. 2a to 4, said separation means 73 preferably consist of a balloon 73a.

Said second part 72″ of said expansion chamber 72 is therefore completely contained in said balloon 73a and said contrast means consist of gas pressurized at a pressure B, with which balloon 73a is filled through a suitable filling valve 73b. Advantageously, said containment element 71 is conveniently provided with a closure plug 75 on which said filling valve 73b is provided to allow the filling of said balloon 73a with gas.

With reference to FIG. 2a, a first embodiment of suspension 10 according to the present invention provides for the accumulator 70 having a variable volume be added to the suspension and tilting system of known type without particular modifications to the system itself. More specifically, the second accumulator 70 having a variable volume is directly connected to the first accumulator 60 by simply replacing the lower closure plug 63 of said first accumulator 60. Here, the charge of the pressure of the gas in the first accumulator 60 is carried out by means of a first filling valve 200 once said second accumulator 70 is connected, while the charge of the pressure of the gas in the second accumulator 70 having a variable volume is carried out by means of a second filling valve 300 arranged on said second accumulator 70.

With reference to FIG. 2b, a second embodiment of suspension 10′ according to the present invention differs from the one shown in FIG. 2a in that said second accumulator 70 having a variable volume is directly connected to the closure plug 63 by means of a nipple 63b accommodated in place of valve 63a shown in FIG. 1 in the prepared seat. According to this configuration, the adjustment of the pressure of the lower chamber 62 of said accumulator may be possible only when the second accumulator 70 has been connected, and by means of said first filling valve 200.

The charge of said second accumulator 70 may occur by means of a dedicated filling valve indicated by numeral 300, which is entirely similar to valve 73b shown in FIG. 5 provided on plug 75 of said second accumulator 70.

Among the advantages of the configuration shown in FIG. 2b, it is worth noting that the second accumulator 70 having a variable volume can be connected without modifications to the suspension system, and in particular to the first accumulator 60. Indeed, by removing valve 63a and replacing said valve with a nipple 63b, the second accumulator 70 having a variable volume may be connected directly to the closure plug 63.

With this configuration, as well as with the configuration in FIG. 2a, the pressure in the first accumulator is charged upon connection of the second accumulator 70 having a variable volume.

With reference to FIG. 2c, a third embodiment of suspension 10″ according to the present invention differs from the one shown in FIG. 2a in that a third accumulator 76 having a variable volume is connected to the second accumulator 70 having a variable volume. The gradual engagement of the suspension may be further improved with this type of configuration, and accordingly the driving comfort, as better explained below.

Also in this case, the charge of the first accumulator 60 may occur by means of a first filling valve 200, with the second accumulator 70 being connected. Similarly, the charge of the second accumulator 70 may occur by means of a second filling valve 200′ arranged on the stretch of connection connecting said third accumulator 76 with said second accumulator 70. Finally, the charge of said third accumulator 76 occurs by means of a dedicated charge 300 similarly to that described with reference to the embodiments in FIGS. 2a and 2b.

With reference to FIG. 2d, in this embodiment the connection of the second accumulator 70 having a variable volume to the first accumulator 60 preferably occurs by means of a flexible tube 64 adapted to directly connect valve 63a arranged on said plug 63 to the second accumulator 70 having a variable volume. This embodiment is particularly preferred if a suspension and tilting system of an existing vehicle is to be modified according to the present invention without modifying anything.

Indeed, the integration of the added accumulator on an existing HTS system or HTS system already in use on the market materializes by screwing the threaded connector 64a of the flexible tube 64 to valve 63a. Therefore, the solution lends itself to adapting existing suspension systems.

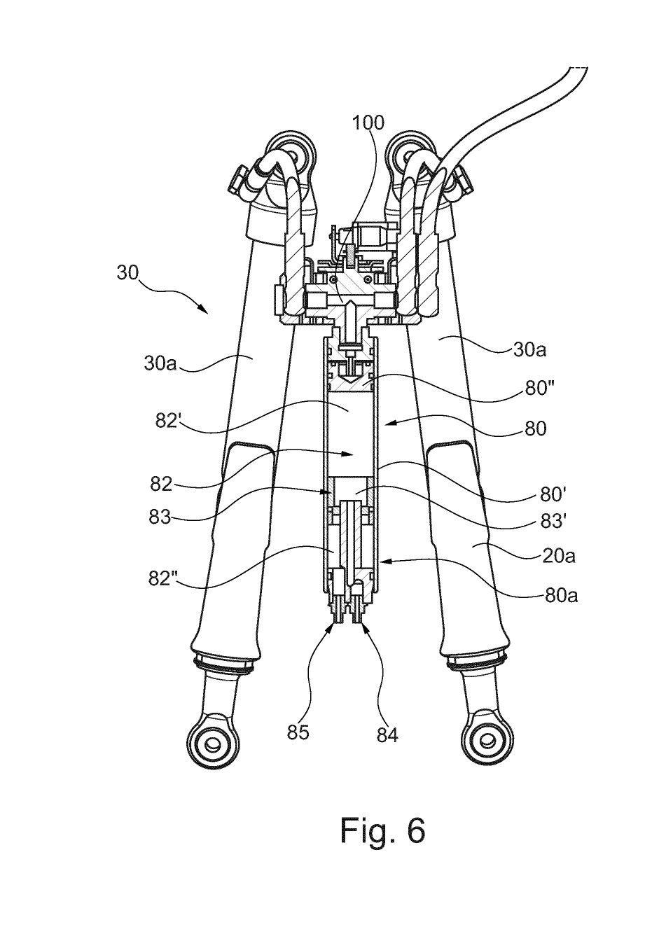

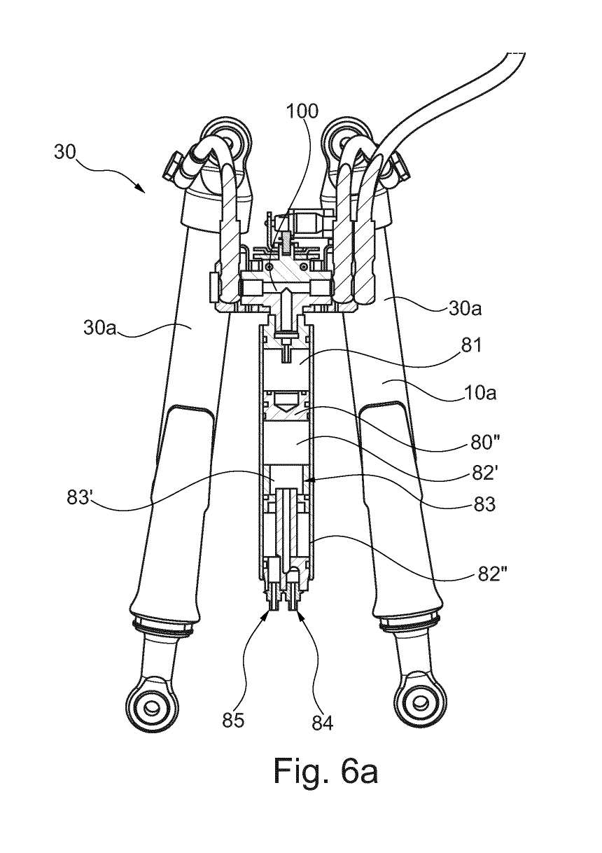

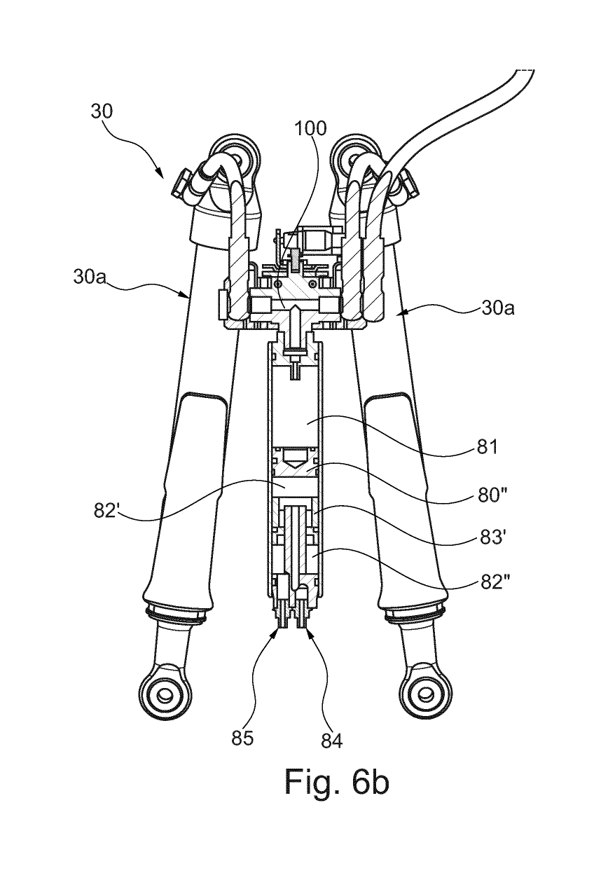

In an alternative embodiment of suspension 30 according to the present invention shown by way of example in FIGS. 6, 6a and 6b, said second accumulator having a variable volume is shown integrated in the first accumulator 80.

More specifically, said first accumulator 80 comprises a containment cylinder 80′, closed at the bottom by a bottom wall, internally provided with a first partition wall 80″ slidably associated within said containment cylinder 80′, which is thus divided into an upper chamber 81 and a lower chamber 82.

Advantageously, said lower chamber 82 of said first accumulator 80 in turn comprises separation means 83 adapted to divide said lower chamber 82 of said first accumulator 80 into two parts. Said separation means 83 preferably comprise here a second partition wall 83′ adapted to divide said lower chamber 82 into two parts; a first part 82′ between said first partition wall 80″ and said second partition wall 83′, a second part 82″ between said second partition wall 83′ and the bottom wall of said containment cylinder 80′.

Gas is present at a first pressure value, generally indicated by A, in the first part 82′ of said lower chamber 82 between said first partition wall 80″ and said second partition wall 83′.

Therefore, in the configuration hereto described, said accumulator 80a having a variable volume is obtained inside said first accumulator 80.

Operatively, said upper chamber 81 of said first accumulator 80 is in fluid connection with the hydraulic circuit connecting said shock absorbers 10a to one another, and therefore it is configured to receive the working fluid (typically oil) enclosed in the upper chambers of said shock absorbers 10a.

Therefore, the working fluid is capable of flowing inside the upper chamber 81 of said first accumulator 80 and counteracting said first partition wall 80″.

Gas is present at a second pressure value, generally indicated by B, in the second part 82″ of said lower chamber 82 between said second partition wall 83′ and the bottom wall of said containment cylinder 80′.

When the thrust exerted on said second partition wall 83′ by pressure A of the gas contained in said first part 82′ of said lower chamber 82 exceeds the force of reaction exerted by pressure B of the gas contained in said second part 82″ of said lower chamber 82, the volume of the lower chamber 82″ will be reduced and the first accumulator 80 will behave like an accumulator having a variable volume; vice versa, as long as the thrust exerted on said second partition wall 83′ by pressure A of the gas contained in said first part 82′ of said lower chamber 82 is lower than the force of reaction exerted by pressure B of the gas contained in said second part 82″ of said lower chamber 82, the first accumulator 80 will behave like a traditional accumulator.

Due to the possibility of increasing the volume inside accumulator 80, same becomes an accumulator having a variable volume and the suspension system according to the present invention therefore allows the drawbacks which are typical of gas suspensions to be obviated, in particular by obviating an excessive rigidity of the suspension from the second part of the travel up to the stroke end. Advantageously, said first accumulator 80 will be provided with a first gas filling valve 84 for filling the gas contained in said first part 82′ of said lower chamber 82, and with a second gas filling valve 85 for filling the gas contained in said second part 82″ of said lower chamber 82.

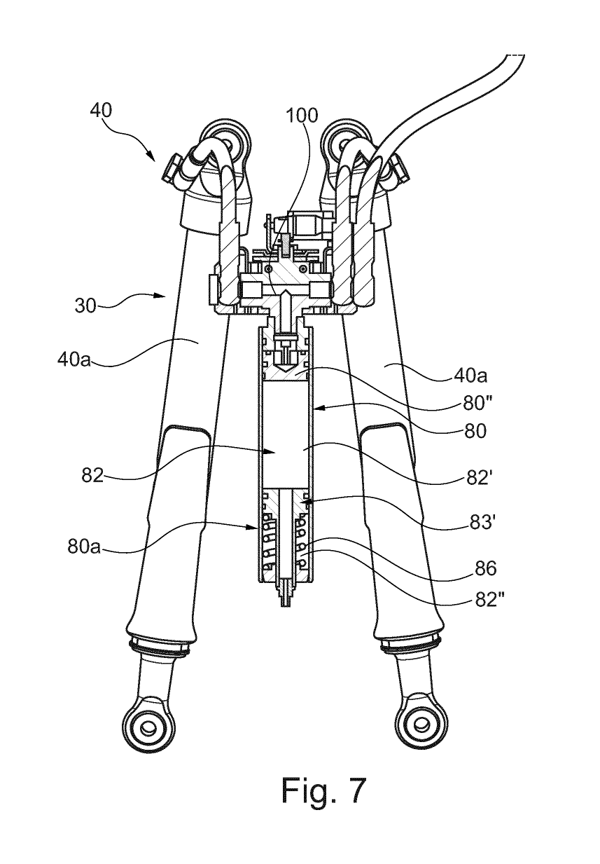

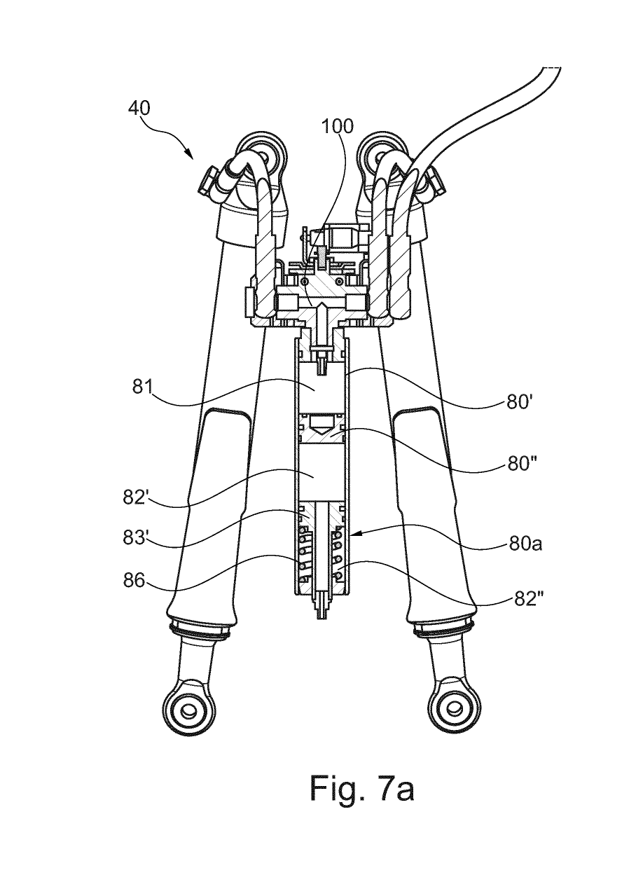

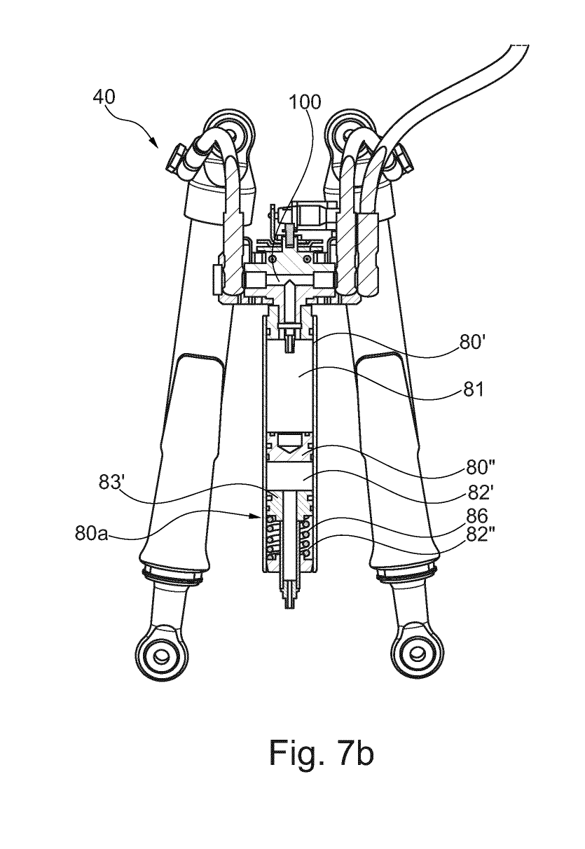

In an alternative embodiment of the present invention shown in FIGS. 7 and 7a, the suspension and tilting system 40 comprises a first accumulator 80 which, similarly to that shown above, in turn comprises a first 80″ and a second 83′ partition wall, however said second part 82″ of said lower chamber 82, which is arranged below said second partition wall 83′, advantageously comprises elastic means, for example a helical spring 86 interposed between the bottom wall of said containment cylinder 80′ and said second partition wall 83′.

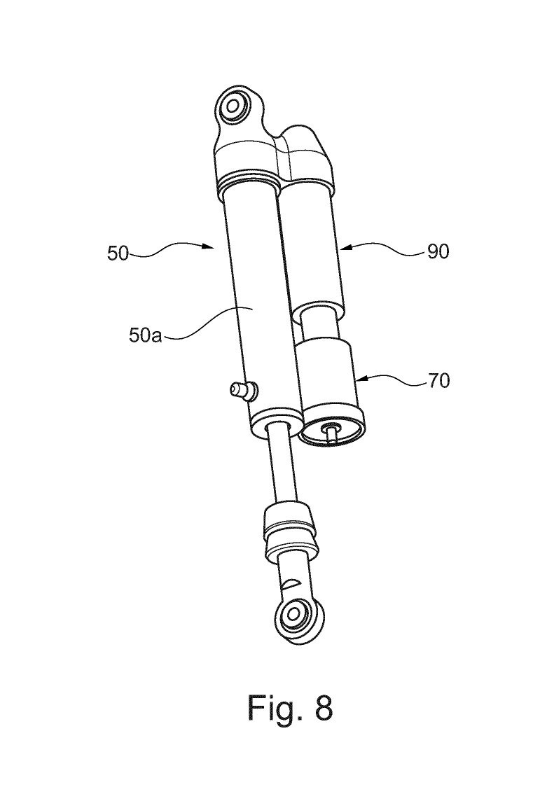

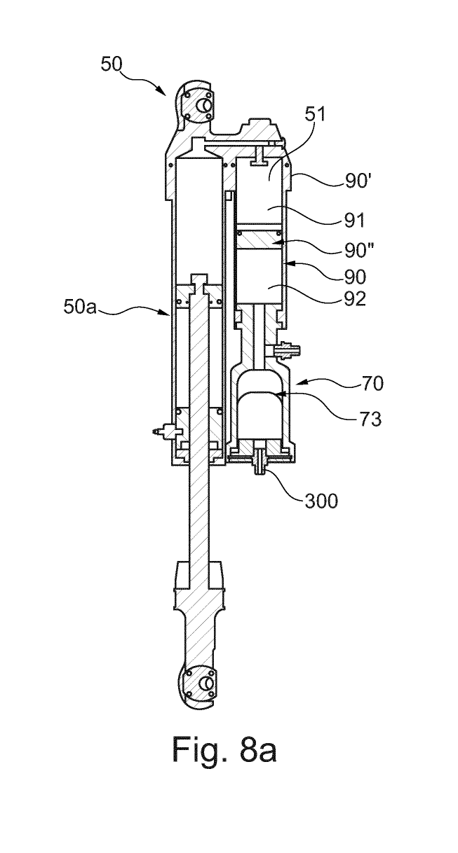

According to a further embodiment shown by way of example in FIGS. 8 and 8a, the improved suspension 50 according to the present invention comprises a shock absorber 50a comprising at least one oil chamber 51 in fluid connection with a first accumulator 90 comprising a containment cylinder 90′ internally housing a first partition wall 90″, slidably associated within said containment cylinder 90′ which is thus divided into an upper chamber 91 and a lower chamber 92.

Advantageously, a pressurized gas is conveniently contained in said lower chamber 92.

Suspension 50 further comprises a second accumulator 70 having a variable volume, having the same features described above with reference to the embodiment shown in FIG. 5.

Said second accumulator 70 is in fluid connection with said first accumulator 90.

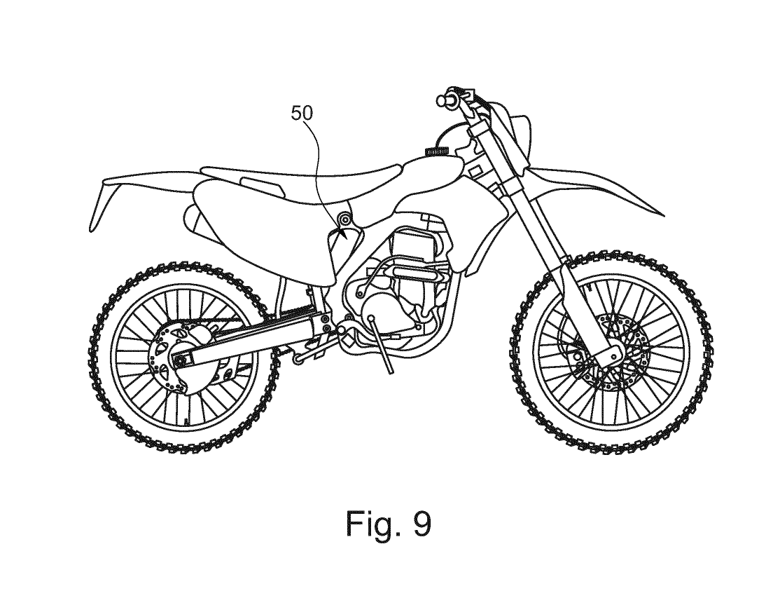

The suspension according to this embodiment can also be used on motorcycles provided with rear mono-shock absorber, as depicted in FIG. 9.

It has thus been shown how the improved suspension according to the present invention achieves the predetermined tasks and objects.

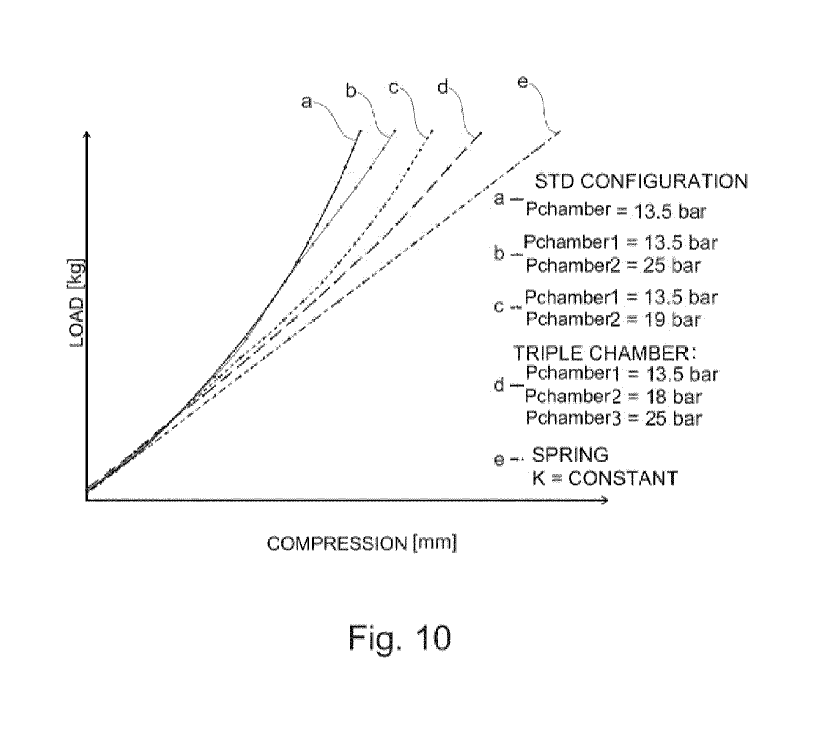

It is worth noting the following, with particular reference to the graph in FIG. 10 showing the compression trend of the suspension (expressed in mm) as the load applied (expressed in kg) varies.

The line indicated by letter a in the graph depicts the behavior of an HTS suspension in standard configuration, i.e. according to the known configuration of FIG. 1.

As is noted from the trend in the graph, the suspension has an excessively progressive reaction, i.e. in the second part of the compression the load increases excessively, which is very different with respect to how much it increases in a spring suspension with a constant elastic constant K, the behavior of which is depicted by the line indicated by letter e in the graph.

The line indicated by letter b depicts the behavior of a suspension according to the present invention according to, for example, the embodiment shown in FIGS. 2a, 2b, 2d, 3, 6, 7 and 8 in which a second accumulator having a variable volume is associated with the first accumulator.

It is worth noting how the second accumulator contributes to modifying the dynamic behavior of the suspension by implementing the progressive behavior which is typical of a gas suspension and therefore making the response of the suspension more linear.

The line indicated by letter c in the graph depicts the response of the same configuration in which different pressures are implemented in the accumulators.

Line d depicts the behavior of a suspension according to the present invention according to, for example, the embodiment shown in FIG. 2c, in which a third accumulator having a variable volume is associated with the first two accumulators.

It is worth noting how the progressive behavior of the suspension is further reduced.

It is apparent from the graph that, with respect to curve a depicting a suspension provided with a single accumulator, and with respect to curve e depicting the behavior of a helical spring suspension having an elastic constant K, the curves b, c and d are positioned in intermediate position, therefore not excessively progressive like the system provided with one accumulator alone, and not excessively yielding like what occurs instead in the case of a spring with K constant.

This results also in driving conditions, for example of two people, with driver and passenger, in which the behavior of the suspension does not become excessively rigid as would occur with a single accumulator suspension when disconnections of the ground are encountered during driving: considering that the first part of compression of the suspension is caused by the weight of the passenger which is added to the one of the driver, the second remaining part of compression ensuring the driving comfort is less rigid but in any case is not excessively soft like in the case of elastic spring with constant k, which normally by default has the characteristic of quickly going to stroke end.

The intermediate position, where the curves of the suspension are positioned according to the present invention, corresponds to the best comfort level perceived when using the vehicle.

Moreover, in addition to the above improvements to the comfort level, when the improved suspension according to the present invention is associated with a tilting system of the wheels of a vehicle with tilting wheels, as when the invention is applied to the HTS suspension and tilting system shown in FIG. 1 or to similar systems, the invention allows to obtain a different transfer of the load during braking, which positively affects the entry of the vehicle into a bend.

Thereby, it was experimentally detected that by changing the transfer value of the load during braking, in particular by increasing the transfer of the load due to a less rigid response of the suspension during the initial load step, the pressures of the oil inside the chambers accordingly vary significantly, in particular they increase, and accordingly the frictions exerted by the gaskets on the seal elements affect the sliding of the parts of the HTS. Thus, a feeling of increased stability is obtained in the step of setting up the bend: the hydraulic gaskets are energized by the pressure itself of the oil which, having an increased value, increasingly create friction on the movement of the pistons on the cylinders of the HTS, and therefore the tilting movement of the vehicle, a condition which makes the driving sensation pleasant in the first step of travelling the bend.

Several changes, modifications, variations and other uses and applications of the invention at hand will become apparent to those skilled in the art after considering the description and the accompanying drawings which show the preferred embodiments thereof. All such changes, modifications, variations and other uses and applications which do not depart from the scope of the invention as defined by the appended claims, which form an integral part of the text, are considered to be covered by the present invention.

1. An improved suspension, comprising:
at least one shock absorber;
at least a first gas accumulator; and at least a second accumulator having a variable volume, operatively connected to said first accumulator.

2. The suspension of claim 1, further comprising a pair of shock absorbers, in fluid connection by means of a connecting duct, and in fluid connection with said first accumulator.

3. The suspension of claim 2, wherein said first accumulator comprises a containment cylinder having a bottom closed by a bottom wall, said containment cylinder internally provided with a first partition wall slidably associated within said containment cylinder and dividing said containment cylinder into an upper chamber to receive working fluid coming from the connecting duct, and into a lower chamber containing gas.

4. The suspension of claim 3, wherein said second accumulator having a variable volume comprises a containment element separated from said containment cylinder of said first accumulator, and said containment element defining inside the second accumulator an expansion chamber having a variable volume.

5. The suspension of claim 4, wherein said containment element comprises inside thereof separation means dividing said expansion chamber having a variable volume into a first part which is in fluid communication with said lower chamber of said first accumulator, and into a second part which includes contrast means suitable to counteract the displacement of said separation means, thus counteracting the volume increase of said first part of said expansion chamber having a variable volume.

6. The suspension of claim 5, wherein said separation means comprise a balloon and wherein said contrast means are constituted by gas filling said balloon.

7. The suspension of claim 1, wherein said second accumulator having a variable volume is formed inside said first accumulator.

8. The suspension of claim 7, wherein said first accumulator comprises a cylindrical containment cylinder having a bottom closed by a bottom wall, internally provided with a first partition wall, slidably associated within said containment cylinder, dividing said containment cylinder into an upper chamber and a lower chamber.

9. The suspension of claim 8, wherein said lower chamber of said first accumulator comprises separation means dividing said lower chamber of said first accumulator into two parts.

10. The suspension of claim 9, wherein said separation means comprise a second partition wall, so that said lower chamber of said first accumulator is divided into a first part comprised between said first partition wall and said second partition wall, and into a second part comprised between said second partition wall and the bottom wall of said containment cylinder.

11. The suspension of claim 10, wherein gas at a first pressure value (A) is present in said first part of said lower chamber, and wherein gas at a second pressure value (B) is present in said second part of said lower chamber.

12. The suspension of claim 10, wherein said second part of said lower chamber of said first accumulator comprises elastic means interposed between the bottom wall of said containment cylinder and said second partition wall.

13. The suspension of claim 12, wherein said elastic means comprise a helical spring.

14. The suspension of claim 1, wherein said shock absorber comprises at least one oil chamber in fluid connection with a first accumulator comprising a containment cylinder internally housing a first partition wall, slidably associated within said containment cylinder which is thus divided into an upper chamber and a lower chamber, pressurized gas being present in said lower chamber.

15. The suspension of claim 14, wherein said second accumulator having a variable volume is in fluid connection with said lower chamber of said first accumulator.

16. A vehicle with two or more wheels, comprising the improved suspension of claim 1.
